(19) United States
(12) Patent Application Publication
(10) Pub. No.: US 2023/0344370 A1
(43) Pub. Date: Oct. 26, 2023

(54) METHODS FOR GENERATING ELECTROMAGNETIC FORCE-FIELDS

(71) Applicants: James Howard Bushong, JR., Skillman, NJ (US); Henry James Bushong, Skillman, NJ (US)

(72) Inventors: James Howard Bushong, JR., Skillman, NJ (US); Henry James Bushong, Skillman, NJ (US)

(21) Appl. No.: 18/136,901

(22) Filed: Apr. 20, 2023

Related U.S. Application Data
(60) Provisional application No. 63/372,995, filed on Apr. 20, 2022.

(51) Int. Cl. H02N 11/00

(52) U.S. Cl. CPC H02N 11/006

(57) ABSTRACT

The present invention offers methods for generating electromagnetic force-fields. The methods utilize a vortex of rapidly rotating discrete matter that may self-generate electromagnetic field and magnetic compression in the Z-axis of the vortex to create an induced electromagnetic force-field in the eye region of the vortex. The induced electromagnetic force-field acts substantially orthogonally outward from θ-plane of the vortex and substantially parallel to the Z-axis of the vortex, and may be harnessed as useful force for engines, motors, rockets, turbines, and/or other applications where power, pressure, propulsion, energy, and/or force are needed. Certain embodiments may also achieve nuclear fusion within the vortex that may be utilized to help power the methods of the present invention and/or be utilized for additional applications where energy is needed.

### CROSS REFERENCE TO RELATED APPLICATIONS

This application is a U.S. Non-Provisional Patent Application entitled, “METHODS FOR GENERATING ELECTROMAGNETIC FORCE-FIELDS”, which claims priority to co-pending U.S. Provisional Patent Application No. 63/372,995 filed on Apr. 20, 2022, entitled, “Methods for Electromagnetic Force-Fields”, the entire disclosures of which are hereby incorporated by reference herein.

### FIELD OF THE INVENTION

The present invention relates generally to methods of generating electromagnetic force-fields. The utility of the present invention includes the potential uses of generating force for engines, motors, rockets, turbines, and/or other applications where power, pressure, propulsion, energy, and/or force are needed.

### BACKGROUND ART

Many typical sources used to generate the force needed to produce energy, power, pressure, and/or propulsion include, but are not limited to, combustion processes of fossil fuels. Alternatives to fossil fuel combustion continue to gain increasing attention in the present era. Power for motors is typically generated by a solid-state rotating magnetic coil that generates electricity via the Faraday-effect.

Present-day conventional stellar formation models demonstrate jets of matter being expelled with tremendous force orthogonally from a central core region of an accretion disk during the formation process. It is difficult to reconcile such jets of matter being expelled orthogonally to the plane of rotation with the conventional theory that stellar accretion disks occur due to gravitational collapse to a central mass with flattening of accretion matter along the axis of rotation. There is no known theory of gravity that suggests collapse of matter along one axis/plane (e.g. xy plane in Cartesian coordinates or θ-plane in cylindrical coordinates) while an orthogonal axis/plane (e.g. Z axis) realizes concurrent expulsion of matter.

The primary inventor of the present invention asserts that stellar accretion disks are not created via gravitational collapse but instead are created via vortex with a self-created eye region akin to the eye of a tornado or hurricane observed on Earth. The fact that the orthogonal expulsion of matter in the central core region of stellar accretion disks cannot be explained via conventional gravitational collapse theory indicates that the alternative assertions and methods of the present invention have been overlooked. The present invention of producing and harnessing the induced electromagnetic force-field in the eye region has been missing from societal knowledge, and the apparatus and methods of the present invention modeled along the primary inventor's astrophysics assertions and secondary author's computational models are therefore novel and highly relevant with many potential benefits to society.

### SUMMARY OF INVENTION

The present invention relates generally to methods for generating electromagnetic force-fields for use in any application where useful power, work, propulsion, or energy from the methods can be obtained and utilized. The invention may offer advantages compared to conventional methods of generating force; such as greater force output, more efficient force output, less complex methods and apparatus for force output, greater force output per unit apparatus size, more economical force output, and force output that can reduce humanities' dependence on combustion of fossil fuels. The methods of the invention can also offer the potential as an alternative method for propulsion in place of conventional combustion processes.

The primary inventor of the present invention asserts that the eye region of the stellar accretion vortex comprises a strong induced electromagnetic force-field that acts substantially orthogonal to the rotational plane of the vortex and wherein the force-field is directed outward away from the top and bottom faces of the vortex throughout the eye region. The inventor further asserts that when stellar accretion matter crosses over the eye region at the top and bottom boundary surfaces of the accretion vortex, the matter encounters the strong induced electromagnetic force-field and is forcibly ejected into space and this explains the jets of matter being expelled in e.g. the +Z and −Z axis directions that are orthogonal to the e.g. xy/θ rotational plane of stellar accretion disks. Even when accretion matter does not cross over the eye region to reveal this force-field, the inventor assert that the force-field is still present so long as the vortex generates a sufficient electromagnetic field and associated magnetic compression within the vortex such that it induces an additional electromagnetic force-field acting between the inner boundary wall of the vortex and throughout the eye region of the vortex. The primary inventor asserts that the induced stellar electromagnetic force-field can be scaled for generating useful force, energy, and propulsion applications with the correct selection of state and density of matter, imparting sufficient angular momentum (rotational velocity and acceleration) of the matter to form a vortex wherein an electromagnetic field is generated within the vortex, and sufficient magnetic pressure spawned by the electromagnetic field acting primarily along the Z-axis such that the θ-plane of the vortex is substantially compressed.

The methods of the present invention utilize discrete matter rotating around a central core eye region. The discrete matter is selected from the list of any or all of gas, plasma, and dust. As used herein, the term discrete matter refers to matter wherein matter may move independently of other particles. The term discrete matter is meant to differentiate from non-discrete matter of for example particles of matter bonded and/or bound together in e.g. solid magnetic coils used in conventional electromagnetic processes. Sufficient angular kinetic motion from e.g. a centrifuge apparatus or other means of imparting rotational motion is applied to the discrete matter such that the matter forms a vortex around the central core eye region. An external electric field rotating in the θ-plane can be useful for inducing high-speed θ-plane rotational motion of the discrete matter within the apparatus, as a replacement to or in addition to any rotational motion of the apparatus itself (of e.g. an ultracentrifuge). The central core eye region may be a rigid physical barrier such that the vortex rotates around the physical barrier, or the central core eye region may be a naturally formed eye region that is self-induced by the rotating vortex of matter as in e.g. the eye that forms naturally in a tornado or hurricane vortex. The central core eye region allows electromagnetic force-fields, including induced electromagnetic force-fields, to form and traverse throughout the central core eye region and the boundary wall between the vortex and the central core eye region. The central core eye region may be formed by e.g. a hollow cylindrical physical barrier such that the discrete matter cannot pass through the barrier while allowing induced electromagnetic force-field to form and traverse within the interior space of the barrier and along the boundary between the inner wall of the vortex and the barrier. The central core eye region may also be formed by e.g. a hollow cylindrical physical barrier that may allow some amount of the discrete matter to pass through the barrier such as in e.g. small perforations in the barrier or e.g. a pressure-activated valve.

Selection of the matter utilized in the methods of the present invention, the amount of matter and any ratio of matter therein, and angular velocity of the matter is such that the rotating vortex of matter generates electric charge. The electric charge can be generated by one or more of the processes from friction-induced, collision-induced, heat-induced, applied external electric current-induced, applied external magnetic field-induced, or any other method of creating electric charge. In any of the methods of the present invention, ionized gas (plasma) can be created in-situ via one or more forces of the vortex process or external forces such as electrodes, even if the matter is initially non-ionized gas.

The generated electric charge, the charge distribution, the conduction, and/or the convection-displacement currents in the vortex of the present invention generate an electric field within the vortex that immediately spawns a magnetic field in accordance with known electromagnetic theory. A magnetic field produces a magnetic force that is known to behave as normal pressure (force per area over which the force acts).

The rotating discrete matter can create a well-organized vortex of electric charge and electric field rotating about the central core eye region, producing a well-organized magnetic field and magnetic pressure that compresses the discrete matter primarily in the height (Z) axis convention of the present invention and thereby compressing the θ-planes of the vortex. As the discrete matter compresses the θ-planes of the vortex with the methods of the present invention, an induced electromagnetic force-field is generated in the central core eye region of the vortex. As used herein, the induced electromagnetic force-field is referred to as the orthogonal-outward vortex eye electromagnetic force-field, or OOVEEM force-field for brevity. The OOVEEM force-field acts in directions substantially parallel to the central core eye region height axis as in e.g. the Z-axis that is orthogonal to the rotational xy-plane (in Cartesian coordinates) or θ-plane (in cylindrical coordinates) of the vortex. Depending on the configuration of North magnetic pole regions and South magnetic pole of the vortex of the present invention, the OOVEEM force-field can act substantially outward from the vortex in both +Z and −Z axis or the OOVEEM force-field can act substantially outward in only the +Z or −Z axis.

In some embodiments, magnetic field lines that originate within the vortex can diverge from North-magnetic pole regions located in the regions along the inner wall boundary between the inside wall of the vortex and the central core eye region of the vortex and the top and bottom surface regions of the vortex, and then converge back to a South-magnetic pole at the midpoint θ-plane (xy-plane in Cartesian coordinates) at the midpoint apparatus height on the Z axis (referred to herein as the Z-central θ-plane) due to natural symmetry and dynamic uniformity of electric field, magnetic field, and magnetic pressure acting equally in the +Z and −Z directions with the methods of the present invention. The convergence of the magnetic field lines upon the Z-central θ-plane may optionally be artificially enhanced and strengthened utilizing a plate with high negative charge affinity placed at the Z-central θ-plane to serve as an enhanced South-magnetic pole. In these embodiments, the OOVEEM force-field is directed substantially parallel along the height axis of the eye region of the vortex and is directed in both the +Z and −Z axis away from and orthogonal to the Z-central θ-plane. The OOVEEM force-field can be harnessed for useful force energy via open outlets at the top and bottom of the central core eye region, referred to herein as the open plus-Z top θ-plane and open minus-Z bottom θ-plane of the central core eye region, respectively. For applications where it is desirable to harness the force in only one direction such as e.g. propulsion, an e.g. conduit can be utilized such that the force in one of the Z-axis directions can be redirected to the opposite Z-axis direction.

In some embodiments, magnetic field lines that originate within the vortex can diverge from North-magnetic pole regions located in the regions along the inner wall boundary between the inside wall of the vortex and the central core eye region of the vortex and the top and bottom surface regions of the vortex, and then converge back to an artificially dislocated South-magnetic pole at either the top or bottom Z-axis θ-plane region (xy-plane of Cartesian coordinates) of the apparatus, referred to herein as the plus-Z-top θ-plane and minus-Z-bottom θ-plane of the apparatus, respectively. In these embodiments, the artificially dislocated South-magnetic pole is created via a plate of large negative charge affinity placed at either the plus-Z top θ-plane (to make the top surface of the apparatus the South magnetic pole) or the minus-Z bottom θ-plane (to make the bottom surface of the apparatus the South magnetic pole) such that the magnetic field lines diverging from North-magnetic pole regions preferentially converge to the plate. In these embodiments, compression of the vortex occurs in only one Z-axis direction as the magnetic compression force of the vortex is directed toward the artificially dislocated South-magnetic pole. In these embodiments, the OOVEEM force-field is directed substantially parallel along the height axis of the eye region of the vortex and is directed in the +Z direction when the plate is placed at the minus-Z bottom θ-plane of the apparatus and in the −Z direction when the plate is placed at the plus-Z top θ-plane surface of the apparatus. In these embodiments, the OOVEEM force-field can be harnessed for useful force energy via an open outlet of the central core eye region corresponding to the direction of the OOVEEM force-field; for example, an open outlet at the minus-Z bottom θ-plane surface of the central core region when the plate is placed at the plus-Z top θ-plane of the apparatus and wherein the plate also covers the plus-Z top θ-plane of the central core region so that all force-energy of the OOVEEM is harnessed out the open outlet at the minus-Z bottom θ-plane surface of the central core eye region.

In some embodiments, it may be beneficial to inject discrete matter to pass over the OOVEEM force-field region at boundary regions around either or both of the plus-Z top θ-plane and minus-Z bottom θ-plane of the central core eye region and/or in conduit placed at the plus-Z top θ-plane outlet and/or minus-Z bottom θ-plane outlet of the central core eye region. This can enable imparting of substantial momentum to the discrete matter from the OOVEEM force-field it encounters as the matter crosses the central core eye region of the vortex utilizing the methods of the present invention. The substantial momentum imparted to the discrete matter could enable enhanced harnessing of the OOVEEM force-field for various applications where power, pressure, propulsion, force, or energy are needed.

In some embodiments, the discrete matter may be continuously injected into the vortex region of the rotational-motion imparting apparatus while undergoing the methods of the present invention to generate induced OOVEEM force-field. In these embodiments, the physical barrier at the central core eye region may have e.g. perforations that allow about the same amount of the continuously injected discrete matter to pass through the physical barrier, such that the OOVEEM force-field imparts substantial momentum to the passing discrete matter in the central core eye region. The substantial momentum imparted to the discrete matter could enable enhanced and continuous harnessing of the OOVEEM force-field for various applications where power, pressure, propulsion, force, or energy are needed in continuous force/energy cycle from the induced OOVEEM force-field methods of the present invention.

In some embodiments, at least some portion of the charged and rotating discrete matter is subject to sufficient force to rip atoms of the matter into constituent free protons, neutrons, and electrons. In these embodiments, the rotational velocity of the vortex can be sufficiently high to provide a mass-based centrifugation such that the heavier-mass free protons and neutrons preferentially organize to a shell-region around the inner wall of the vortex and adjacent to the central core eye region of the vortex, and the lighter-mass free electrons preferentially organize to a shell-region along the outside (further from the center of rotation) of the free proton/neutron shell-region. The free proton/neutron shell-region is positive-charge-rich and the free electron shell-region is negative-charge-rich. In the embodiments, the vortex-enabled centrifuge-effect atomistic parts' separation creates a strongly positive charge along the inner wall of the vortex at the boundary to the central core eye region. The strongly positive charge creates a strong like-charge repulsive force all along the inner wall region and across the vortex central core eye region. The like-charge strong repulsive force can enhance the strength of the OOVEEM force-field produced by the methods of the present invention. Under proper conditions, these embodiments may also be conducive to achieving nuclear fusion in the proton/neutron rich-shell of the vortex, and the nuclear fusion can be beneficial as a source of additional energy.

In some example embodiments, discrete matter selected from any or all of gas, plasma, and dust capable of generating electromagnetic field is placed in an apparatus wherein rotational motion can be imparted to the discrete matter and that has a cylindrical physical barrier at the central core eye region, wherein the physical barrier has a hollow interior that allows induced electromagnetic force-field to form and traverse throughout the interior space of the barrier and along the boundary between the barrier and the discrete matter. With just enough imparted rotation to elevate all particles of the discrete matter and create a uniform vortex of the present invention, the average initial vortex density (defined herein as the total initial mass of discrete matter divided by the initial volume of the vortex) is in the range of about 0.1 to 50 kg per cubic meter of the vortex volume. The discrete matter then undergoes sufficient rotational acceleration to increase the velocity of the matter to the range of about 0.1-10,000 km/sec at the vortex region around the cylindrical boundary at the central core eye region of the apparatus. The electromagnetic field of the vortex increases as the velocity of rotation increases. Magnetic pressure that can be either solely generated by the increasing electromagnetic field of the vortex, or via a combination of magnetic pressure of the electromagnetic field combined with additional applied electromagnetic field, compresses the initial height of the vortex to a final height corresponding to a compression ratio (defined herein as initial vortex height divided by final vortex height) range of between about 2:1 and 50:1. The density of the vortex after compression is in the range of about 0.2-2,500 kg per cubic meter of compressed-height vortex according to the initial vortex density and compression ratio. The example embodiments generate an induced OOVEEM force-field within the inner space of the cylindrical physical barrier and the boundary between the barrier and the vortex.

In some other example embodiments, discrete matter comprising any or all of gas, plasma, and dust capable of generating electromagnetic field is placed in an apparatus wherein rotational motion can be imparted to the discrete matter. With just enough rotation to elevate all particles of the discrete matter and create a uniform vortex of the present invention, the average initial vortex density is in the range of about 0.1 to 50 kg per cubic meter of the vortex volume. The discrete matter then undergoes sufficient rotational acceleration to increase the velocity of the matter to the range of about 0.1-10,000 km/sec at the vortex region around a self-forming central core eye region of the vortex. The electromagnetic field of the vortex increases as the velocity of rotation increases. Magnetic pressure that can be either solely generated by the increasing electromagnetic field of the vortex or via a combination of magnetic pressure of the electromagnetic field combined with additional applied electromagnetic field compresses the initial height of the vortex to a final height corresponding to a compression ratio range of between about 2:1 and 50:1. The density of the vortex after compression is in the range of 0.2-2,500 kg per cubic meter of compressed-height vortex according to the initial vortex density and compression ratio. The example embodiments generate an induced OOVEEM force-field within the central core eye region and along the boundary between the central core eye region and the vortex.

The process conditions such as temperature, velocity, acceleration, density, pressure, boundary conditions, and composition of discrete matter for the vortex can be selected to optimize the conditions that will produce the desired results for the desired application.

### BRIEF DESCRIPTION OF DRAWINGS

The accompanying drawings are incorporated herein and form a part of the specification.

FIG. 1 illustrates a perspective side view of an apparatus configured for rotation to be imparted to form a vortex of discrete matter, according to at least some embodiments disclosed herein;

FIG. 2 illustrates a perspective side view of an apparatus configured for rotation to be imparted to form a vortex of discrete matter, according to at least some embodiments disclosed herein;

FIG. 3 illustrates a perspective side view of an apparatus configured for rotation to be imparted to form a vortex of discrete matter, the apparatus having an inlet, according to at least some embodiments disclosed herein; and

FIG. 4 illustrates a perspective side view of an apparatus configured for rotation to be imparted to form a vortex of discrete matter, the apparatus having a conduit attached to the open plus-Z top θ-plane of the central core eye region and a port, according to at least some embodiments disclosed herein.

### DESCRIPTION OF EMBODIMENTS

Although specific embodiments of the present invention will now be described, it should be understood that such embodiments are by way of example only and merely illustrative of but a small number of the many possible specific embodiments which can represent applications of the principles of the present invention. Changes and modifications by persons skilled in the art to which the present invention pertains are within the spirit, scope and contemplation of the present invention as further defined in the appended claims. All references cited herein are incorporated by reference as if each had been individually incorporated.

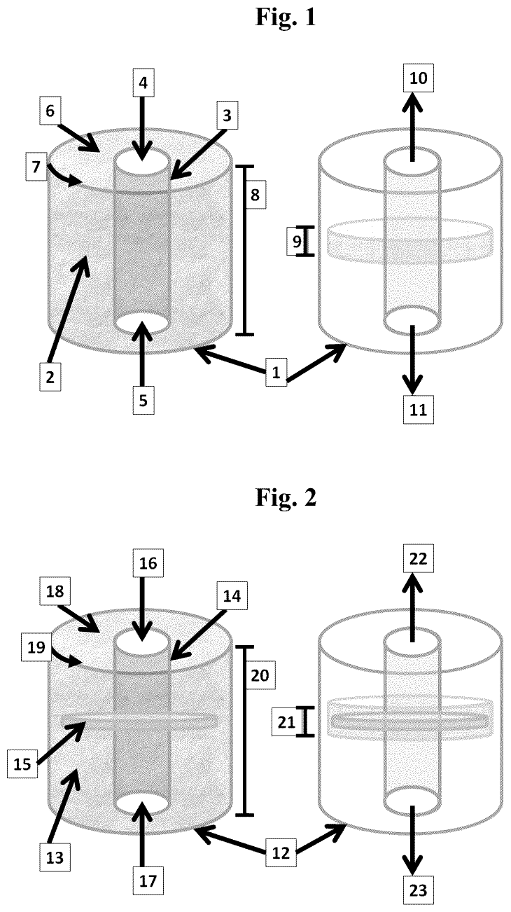

FIG. 1 is an illustration of an apparatus. Reference numeral 1 wherein rotation can be imparted to form a vortex of discrete matter. Reference 2 within the apparatus, wherein the apparatus is shown with transparent walls in this and all drawings for the purpose of revealing the interior features of the apparatus and the present invention, wherein the vortex rotates around a central core eye region formed by a physical barrier. Reference 3 and wherein the physical barrier has a hollow interior. Reference 4 indicates an open plus-Z top θ-plane of the central core eye region. Reference 5 indicates an open minus-Z bottom θ-plane of the central core eye region. Reference 6 indicates the plus-Z top θ-plane of the vortex. Reference 7 indicates the direction of rotation of the plus-Z top θ-plane of the vortex and all other θ-planes of the vortex. Reference 8 indicates the initial height of the vortex. Reference 9 indicates the final height of the vortex after undergoing magnetic compression from both the +Z and −Z axis directions with the methods of the present invention. Reference 10 indicates the direction of the induced OOVEEM force-field acting in the +Z direction out the open plus-Z top θ-plane of the central core eye region. Reference 11 indicates the direction of the induced OOVEEM force-field acting in the -Z direction out the open minus-Z bottom θ-plane of the central core eye region.

FIG. 2 is an illustration of an apparatus. Reference numeral 12 wherein rotation can be imparted to form a vortex of discrete matter. Reference 13 within the apparatus, wherein the vortex rotates around a central core eye region formed by a physical barrier. Reference 14 and wherein the physical barrier has a hollow interior. Reference 15 indicates a plate of high negative charge affinity placed at the mid-point in height of the apparatus, wherein the plate has the shape of a cylinder occupying parts of the Z-central θ-plane region of the apparatus. Reference 16 indicates an open plus-Z top θ-plane of the central core eye region. Reference 17 indicates an open minus-Z bottom θ-plane of the central core eye region. Reference 18 indicates the plus-Z top θ-plane of the vortex. Reference 19 indicates the direction of rotation of the plus-Z top θ-plane of the vortex and all other θ-planes of the vortex. Reference 20 indicates the initial height of the vortex. Reference 21 indicates the final height of the vortex after undergoing magnetic compression from both the +Z and −Z axis directions with the methods of the present invention. Reference 22 indicates the direction of the induced OOVEEM force-field acting in the +Z direction out the open plus-Z top θ-plane of the central core eye region. Reference 23 indicates the direction of the induced OOVEEM force-field acting in the −Z direction out the open minus-Z bottom θ-plane of the central core eye region.

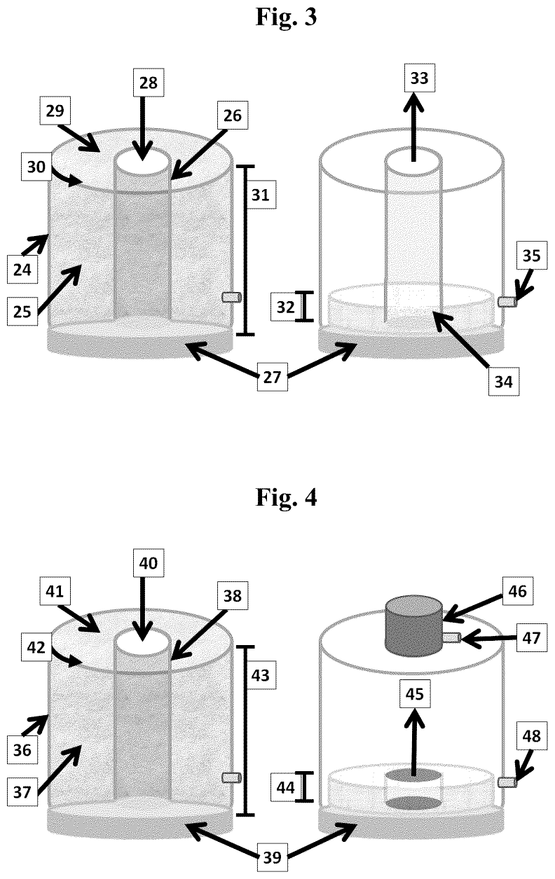

FIG. 3 is an illustration of an apparatus. Reference numeral 24 wherein rotation can be imparted to form a vortex of discrete matter. Reference 25 within the apparatus, wherein the vortex rotates around a central core eye region formed by a physical barrier. Reference 26 and wherein the physical barrier has a hollow interior. Reference 27 indicates a plate of high negative charge affinity placed at the minus-Z bottom θ-plane of the apparatus, wherein the plate has the shape of a cylinder occupying all of the minus-Z bottom θ-plane region of the apparatus. Reference 28 indicates an open plus-Z top θ-plane of the central core eye region. Reference 29 indicates the plus-Z top θ-plane of the vortex. Reference 30 indicates the direction of rotation of the plus-Z top θ-plane of the vortex and all other θ-planes of the vortex. Reference 31 indicates the initial height of the vortex. Reference 32 indicates the final height of the vortex after undergoing magnetic compression in the −Z axis direction such that the vortex is compressed toward the plate with the methods of the present invention. Reference 33 indicates the direction of the induced OOVEEM force-field acting in the +Z direction out the open plus-Z top θ-plane of the central core eye region. Reference 34 indicates a section of the barrier that allows some portion of the discrete matter to pass through to the interior of the barrier when the vortex is compressed, wherein the passing matter has substantial momentum imparted to it in the +Z direction via the OOVEEM force-field. Reference 35 indicates an inlet at which additional amount of the discrete matter can be injected into the apparatus to approximately balance the amount of the passing matter and maintain continuous OOVEEM force-field generation cycle.

FIG. 4 is an illustration of an apparatus. Reference numeral 36 wherein rotation can be imparted to form a vortex of discrete matter. Reference 37 within the apparatus, wherein the vortex rotates around a central core eye region. Reference 38 naturally formed by the vortex. Reference 39 indicates a plate of high negative charge affinity placed at the minus-Z bottom θ-plane of the apparatus, wherein the plate has the shape of a cylinder occupying all of the minus-Z bottom θ-plane region of the apparatus. Reference 40 indicates an open plus-Z top θ-plane of the central core eye region. Reference 41 indicates the plus-Z top θ-plane of the vortex. Reference 42 indicates the direction of rotation of the plus-Z top θ-plane of the vortex and all other θ-planes of the vortex. Reference 43 indicates the initial height of the vortex. Reference 44 indicates the final height of the vortex after undergoing magnetic compression in the −Z axis direction such that the vortex is compressed toward the plate with the methods of the present invention. Reference 45 indicates the direction of the induced OOVEEM force-field acting in the +Z direction out the open plus-Z top θ-plane of the central core eye region. Reference 46 indicates a conduit attached to the open plus-Z top θ-plane of the central core eye region. Reference 47 indicates a port in which gas can be injected into the conduit such that the injected gas gains substantial momentum in the +Z direction from the OOVEEM force-field. Reference 48 indicates an inlet at which additional amount of the discrete matter can be injected into the apparatus as needed to maintain continuous OOVEEM force-field generation cycle.

In one example embodiment, discrete matter comprising a mixture of gas, plasma, and dust capable of generating electromagnetic field is placed in a centrifuge apparatus that has a central core eye region formed by a hollow cylindrical physical barrier such that the matter cannot pass through the barrier but allows induced electromagnetic force-field to form within the interior space of the barrier. With just enough rotation to elevate all particles of the discrete matter and create a uniform vortex, the average initial vortex density is the range of about 0.5-50 kg per cubic meter of the vortex volume. The discrete matter then undergoes sufficient rotational acceleration to increase the velocity of the matter to a range of about 0.1-20 km/sec at the vortex region around the cylindrical barrier. The electromagnetic field of the vortex increases as the velocity of rotation increases. Magnetic pressure that is partly generated by the electromagnetic field of the vortex and partly generated by an external applied electromagnetic field compresses the initial height of the vortex to a final height corresponding to a compression ratio range of about 2:1 to 5:1. The density of the vortex after compression is in the range of about 1-250 kg per cubic meter of final vortex volume. The electromagnetic field and magnetic compression of the vortex generates an induced OOVEEM force-field that acts in the +Z and −Z axis within the central core eye region of the cylindrical barrier.

In another example embodiment, discrete matter comprising a mixture of gas, plasma, and dust capable of generating electromagnetic field is placed in a centrifuge apparatus with no physical boundary at the central core region. With just enough rotation to elevate all particles of the discrete matter and create a uniform vortex, the average initial vortex density is in the range of about 0.5-25 kg per cubic meter of the vortex volume. The discrete matter then undergoes sufficient rotational acceleration to increase the velocity of the matter to a range of about 1-50 km/sec at the vortex region around a self-forming central core eye region of the vortex. The electromagnetic field of the vortex increases as the velocity of rotation increases. Magnetic pressure that is generated by the electromagnetic field of the vortex compresses the initial height of the vortex to a final height corresponding to a compression ratio range of about 3:1 to 10:1. The density of the vortex after compression is in the range of about 1.5-250 kg per cubic meter of final vortex volume. The electromagnetic field and magnetic compression of the vortex generates an induced OOVEEM force-field that acts in the +Z and −Z axis within the central core eye region and along the boundary between the inner wall of the vortex and the central core eye region.

In another example embodiment, discrete matter comprising a mixture of gas, plasma, and dust capable of generating electromagnetic field is placed in a cylindrical apparatus that has a central core eye region formed by a hollow cylindrical physical barrier such that the matter cannot pass through the barrier but allows induced electromagnetic force-field to form within the interior space of the barrier. A plate of high negative charge affinity is placed at the Z-central θ-plane of the apparatus as shown for example in FIG. 2. With just enough rotation to elevate all particles of the discrete matter and create a uniform vortex, the average initial vortex density is in the range of about 0.5 -50 kg per cubic meter of the vortex volume. The discrete matter then undergoes sufficient rotational acceleration to increase the velocity of the matter to a range of about 10-500 km/sec at the vortex region around the cylindrical barrier. The electromagnetic field of the vortex increases as the velocity of rotation increases, and the magnetic field lines that diverge from North magnetic pole regions of the vortex can converge with enhanced strength and symmetry to a South magnetic pole of the vortex at the plate placed at the Z-central θ-plane. Magnetic pressure that is generated by the electromagnetic field of the vortex compresses the initial height of the vortex to a final height corresponding to a compression ratio range of about 5:1 to 20:1. The density of the vortex after compression is in the range of about 2.5-1,000 kg per cubic meter of final vortex volume. The electromagnetic field and magnetic compression of the vortex generates an induced OOVEEM force-field that acts in the +Z and −Z axis within the central core eye region of the cylindrical barrier. The OOVEEM force-field is harnessed for useful force energy via open outlets at the top and bottom of the central core eye region.

In another example embodiment, discrete matter comprising a mixture of gas, plasma, and dust capable of generating electromagnetic field is placed in a cylindrical apparatus with central core eye region formed by a hollow cylindrical physical barrier with a section that has slight wall porosity to allow some amount of the discrete matter to pass through the barrier when the vortex is compressed, and wherein the barrier allows induced electromagnetic force-field to form within the interior space of the barrier. A plate of high negative charge affinity is placed at the minus-Z bottom θ-plane surface of the apparatus as shown for example in FIG. 3. With just enough rotation to elevate all particles of the discrete matter and create a uniform vortex, the average initial vortex density is about 0.25-25 kg per cubic meter of the vortex volume. The discrete matter then undergoes sufficient rotational acceleration to increase the velocity of the matter to a range of about 20-1,000 km/sec at the vortex region around the cylindrical barrier. The electromagnetic field of the vortex increases as the velocity of rotation increases, and magnetic field lines that originate within the vortex can diverge from North-magnetic pole regions located in the regions along the inner wall boundary between the inside wall of the vortex and the central core eye region of the vortex and the top surface region of the vortex, and then converge back to an artificially dislocated South-magnetic pole created by the plate placed at the minus-Z bottom θ-plane of the vortex. Magnetic pressure that is generated by the electromagnetic field of the vortex compresses the initial height of the vortex to a final height corresponding to a compression ratio range of about 7:1 to 30:1. The density of the vortex after compression is in the range of about 1.7-750 kg per cubic meter of final vortex volume. The electromagnetic field and magnetic compression of the vortex generates an induced OOVEEM force-field that acts substantially only in the +Z direction within the central core eye region because of the location of the plate creating the artificially dislocated South-magnetic pole. The OOVEEM force-field is harnessed for useful force energy via an open outlet at the plus-Z top θ-plane surface of the central core eye region, wherein the portion of the discrete matter that passes through to the interior of the barrier gains substantial momentum from the OOVEEM force-field and the momentum is utilized for direct-drive propulsion force. Additional amount of the discrete matter is continuously injected into the apparatus to balance the amount of the passing matter and create continuous direct-drive propulsion force.

In another example embodiment, discrete matter comprising a mixture of gas, plasma, and dust capable of generating electromagnetic field is placed in an apparatus that has a central core eye region formed by a hollow cylindrical physical barrier such that the matter cannot pass through the barrier but allows induced electromagnetic force-field to form within the interior space of the barrier. A plate of high negative charge affinity is placed at the plus-Z top θ-plane surface of the apparatus. With just enough rotation to elevate all particles of the discrete matter and create a uniform vortex, the average initial vortex density is about 0.1-2.5 kg per cubic meter of the vortex volume. The discrete matter then undergoes sufficient rotational acceleration to increase the velocity of the matter to a range of about 20-1,000 km/sec at the vortex region around a self-forming central core eye region of the vortex. The electromagnetic field of the vortex increases as the velocity of rotation increases, and magnetic field lines that originate within the vortex can diverge from North-magnetic pole regions located in the regions along the inner wall boundary between the inside wall of the vortex and the central core eye region of the vortex and the bottom surface region of the vortex, and then converge back to an artificially dislocated South-magnetic pole created by the plate placed at the plus-Z top θ-plane of the vortex. Magnetic pressure that is generated by the electromagnetic field of the vortex compresses the initial height of the vortex to a final height corresponding to a compression ratio range of about 10:1 to 40:1. The density of the vortex after compression is in the range of about 1-100 kg per cubic meter of final vortex volume. The electromagnetic field and magnetic compression of the vortex generates an induced OOVEEM force-field that acts substantially only in the −Z axis within the central core eye region because of the location of the plate creating the artificially dislocated South-magnetic pole. The OOVEEM force-field is harnessed for useful force energy via an open outlet at the minus-Z bottom θ-plane surface of the central core eye region that leads into conduit. A continuous stream of gas is injected into the conduit such that the OOVEEM force-field imparts substantial momentum to the gas, and the momentum of the gas is utilized to turn turbine for generating electrical energy.

In another example embodiment, discrete matter comprising a mixture of gas, plasma, and dust capable of generating electromagnetic field is placed in an apparatus that has a central core eye region formed by a hollow cylindrical physical barrier such that the matter cannot pass through the barrier but allows induced electromagnetic force-field to form within the interior space of the barrier. With just enough rotation to elevate all particles of the discrete matter and create a uniform vortex, the average initial vortex density is the range of about 0.1-50 kg per cubic meter of the vortex volume. The discrete matter then undergoes sufficient rotational acceleration to increase the velocity of the matter to a range of about 1,000-10,000 km/sec at the vortex region around the cylindrical barrier. At least some portion of the matter is ripped into constituent free protons, neutrons, and electrons as the vortex rotational velocity increases. The electromagnetic field of the vortex increases as the velocity of rotation increases. Magnetic pressure that is generated by the electromagnetic field of the vortex compresses the initial height of the vortex to a final height corresponding to a compression ratio range of about 30:1 to 50:1. The density of the vortex after compression is in the range of about 3-2,500 kg per cubic meter of final vortex volume. The electromagnetic field and magnetic compression of the vortex generates an induced OOVEEM force-field that acts in the +Z and −Z axis within the central core eye region of the cylindrical barrier and along the boundary between the inner wall of the vortex and the cylindrical barrier. The OOVEEM force-field is harnessed for useful force energy via open outlets at the top and bottom of the central core eye region. At least some portion of the free protons and neutrons achieve nuclear fusion via the magnetic compression force combined with the collision force between the free protons and neutrons, and the nuclear fusion provides additional force and energy that can be utilized to continue to power the methods of the present invention and/or be harnessed as additional force and energy to the induced OOVEEM force-field.

Certain conditions such as selection of discrete matter with favorable bulk modulus for compression and electric-field/magnetic field potential, and other considerations such as process temperatures such as those that enable superconductivity, can be selected to enhance and/or overcome any difficulties to achieve the desired results, potentially altering the range of process parameters while still maintaining the scope/benefits of the present invention. In any embodiments, discrete matter selected from any or all of gas, dust, and plasma may be continuously injected into the vortex region of the rotational-motion imparting apparatus as needed to maintain continuous operation and harnessing of useful force/energy cycle from the induced OOVEEM force-field methods of the present invention.

It is within the scope of this invention for any combination of parameters and/or methods in any embodiments may be interchanged as long as an induced OOVEEM force-field is generated and/or harnessed in any way for useful force application.

1. A method for generating an electromagnetic force-field, comprising:
rotating discrete matter, the matter is rotated at sufficient angular velocity to create a vortex around a central core eye region, the vortex of the matter creates electric charge distribution, the electric charge distribution creates an electric field, the electric field creates a magnetic field, the magnetic field creates magnetic pressure acting substantially in an Z-axis such that a height of the vortex of the matter is substantially compressed along a θ-plane of the vortex, the compressed vortex induces the electromagnetic force-field within the central core eye region, and the induced electromagnetic force-field acts substantially orthogonally outward from the θ-plane of the vortex and is substantially parallel to the Z-axis of the vortex.

2. The method of claim 1, wherein the discrete matter is selected from the group consisting of at least one of gas, plasma, and dust.

3. The method of claim 1, wherein the central core eye region is a substantially rigid physical barrier such that the vortex rotates around the physical barrier, and wherein the discrete matter cannot pass through the barrier, and wherein the barrier allows the induced electromagnetic force-field to form and traverse within an interior space of the barrier and outward from one or more open ends of the barrier.

4. The method of claim 1, wherein the central core eye region is a substantially rigid physical barrier such that the vortex rotates around the physical barrier, and wherein the barrier allows the induced electromagnetic force-field to form and traverse within an interior space of the barrier and outward from one or more open ends of the barrier, and wherein the barrier allows some portion of the discrete matter to pass through the barrier when the vortex is compressed, and wherein the discrete matter is continuously injected into an apparatus such that an amount of the discrete matter passing through to the interior of the barrier is approximately balanced with the amount of the discrete matter continuously injected into the apparatus.

5. The method of claim 1, wherein the central core eye region is self-induced by the rotating vortex of the discrete matter forming an inner wall and an eye region around which the vortex rotates.

6. The method of claim 1, wherein magnetic field lines diverging from a North-magnetic pole region of the vortex converge toward a South-magnetic pole that is strengthened with a plate of high negative charge affinity placed at a Z-central θ-plane of an apparatus.

7. The method of claim 1, wherein magnetic field lines diverging from North-magnetic pole regions of the vortex are directed to converge toward an artificially dislocated South-magnetic pole at either a plus-Z-top θ-plane region or a minus-Z-bottom θ-plane region of an apparatus via a plate of large negative charge affinity placed at either the plus-Z top θ-plane region or the minus-Z bottom θ-plane region such that the diverging magnetic field lines preferentially converge to the plate.

8. The method of claim 1, wherein the induced electromagnetic force-field is harnessed in conduit and wherein the discrete matter is selected from the group consisting of at least one of gas, dust, and plasma is injected into the conduit such that the induced electromagnetic force-field imparts substantial momentum to the injected matter.

9. The method of claim 1, wherein the induced electromagnetic force-field is utilized as a force to power the group consisting of at least one of a motor, an engine, a rocket, a turbine, and a direct-drive propulsion.

10. A method for generating an electromagnetic force-field, comprising:
rotating discrete matter, the discrete matter is rotated at a sufficient angular velocity to create a vortex around a central core eye region, the vortex has an average initial vortex density in a range of about 0.1 to about 25 kg per cubic meter, the vortex angular velocity is increased via a rotational acceleration to achieve a vortex velocity in a range of about 0.1 to about 1,000 km/sec in the vortex around the central core eye region, the vortex of the matter creates an electric charge distribution, the electric charge distribution creates an electric field, the electric field creates a magnetic field, the magnetic field creates a magnetic pressure acting substantially in a Z-axis such that a height of the vortex of the matter is substantially compressed to a compression ratio in the range of 2:1 to 40:1; and
inducing, by the compressed vortex, the electromagnetic force-field within the central core eye region, wherein the induced electromagnetic force-field acts substantially orthogonally outward from a θ-plane of the vortex and substantially parallel to the Z-axis of the vortex.

11. The method of claim 10, wherein the discrete matter is selected from the group consisting of at least one of gas, plasma, and dust.

12. The method of claim 10, wherein the central core eye region is a substantially rigid physical barrier such that the vortex rotates around the physical barrier, and wherein the discrete matter cannot pass through the barrier, and wherein the barrier allows the induced electromagnetic force-field to form and traverse within an interior space of the barrier and outward from one or more open ends of the barrier.

13. The method of claim 10, wherein the central core eye region is a substantially rigid physical barrier such that the vortex rotates around the physical barrier, and wherein the barrier allows the induced electromagnetic force-field to form and traverse within an interior space of the barrier and outward from one or more open ends of the barrier, and wherein the barrier allows some portion of the discrete matter to pass through the barrier when the vortex is compressed, and wherein the discrete matter is continuously injected into an apparatus such that an amount of the discrete matter passing through to the interior of the barrier is approximately balanced with the amount of the discrete matter continuously injected into the apparatus.

14. The method of claim 10, wherein the central core eye region is self-induced by the rotating vortex of the discrete matter forming an inner wall and an eye region around which the vortex rotates.

15. The method of claim 10, wherein magnetic field lines diverging from a North-magnetic pole region of the vortex converge toward a South-magnetic pole that is strengthened with a plate of high negative charge affinity placed at a Z-central θ-plane of an apparatus.

16. The method of claim 10, wherein magnetic field lines diverging from North-magnetic pole regions of the vortex are directed to converge toward an artificially dislocated South-magnetic pole at either a plus-Z-top θ-plane region or a minus-Z-bottom θ-plane region of an apparatus via a plate of large negative charge affinity placed at either the plus-Z top θ-plane region or the minus-Z bottom θ-plane region such that the diverging magnetic field lines preferentially converge to the plate.

17. The method of claim 10, wherein the induced electromagnetic force-field is harnessed in conduit and wherein the discrete matter is selected from the group consisting of at least one of gas, dust, and plasma is injected into the conduit such that the induced electromagnetic force-field imparts substantial momentum to the injected matter.

18. The method of claim 10, wherein the induced electromagnetic force-field is utilized as a force to power the group consisting of at least one of a motor, an engine, a rocket, a turbine, and a direct-drive propulsion.

19. A method for generating an electromagnetic force-field comprising:
rotating discrete matter, the matter is rotated at sufficient angular velocity to create a vortex around a central core eye region, the vortex has an average initial vortex density in a range of about 0.1 to about 50 kg per cubic meter, the vortex angular velocity is increased via rotational acceleration to achieve a vortex velocity in a range of about 1,000 to about 10,000 km/sec in the vortex around the central core eye region, at least some portion of the accelerated matter comprises free protons, neutrons, and electrons, wherein the vortex of the matter creates electric charge distribution, the electric charge distribution creates electric field, the electric field creates magnetic field, the magnetic field creates magnetic pressure acting substantially in a Z-axis such that a height of the vortex of the matter is substantially compressed to a compression ratio in the range of 30:1 to 50:1, the compressed vortex induces the electromagnetic force-field within the central core eye region, the induced electromagnetic force-field acts substantially orthogonally outward from θ-plane of the vortex and substantially parallel to the Z-axis of the vortex, and at least some portion of the free protons and the neutrons achieves nuclear fusion.

20. The method of claim 19, wherein the discrete matter is selected from the group consisting of at least one of gas, plasma, and dust.

21. The method of claim 19, wherein the central core eye region is a substantially rigid physical barrier such that the vortex rotates around the physical barrier, and wherein the discrete matter cannot pass through the barrier, and wherein the barrier allows the induced electromagnetic force-field to form and traverse within an interior space of the barrier and outward from one or more open ends of the barrier.

22. The method of claim 19, wherein the central core eye region is a substantially rigid physical barrier such that the vortex rotates around the physical barrier, and wherein the barrier allows the induced electromagnetic force-field to form and traverse within an interior space of the barrier and outward from one or more open ends of the barrier, and wherein the barrier allows some portion of the discrete matter to pass through the barrier when the vortex is compressed, and wherein the discrete matter is continuously injected into an apparatus such that an amount of the discrete matter passing through to the interior of the barrier is approximately balanced with the amount of the discrete matter continuously injected into the apparatus.

23. The method of claim 19, wherein the central core eye region is self-induced by the rotating vortex of the discrete matter forming an inner wall and an eye region around which the vortex rotates.

24. The method of claim 19, wherein magnetic field lines diverging from a North-magnetic pole region of the vortex converge toward a South-magnetic pole that is strengthened with a plate of high negative charge affinity placed at a Z-central θ-plane of an apparatus.

25. The method of claim 19, wherein magnetic field lines diverging from North-magnetic pole regions of the vortex are directed to converge toward an artificially dislocated South-magnetic pole at either a plus-Z-top θ-plane region or a minus-Z-bottom θ-plane region of an apparatus via a plate of large negative charge affinity placed at either the plus-Z top θ-plane region or the minus-Z bottom θ-plane region such that the diverging magnetic field lines preferentially converge to the plate.

26. The method of claim 19, wherein the induced electromagnetic force-field is harnessed in conduit and wherein the discrete matter is selected from the group consisting of at least one of gas, dust, and plasma is injected into the conduit such that the induced electromagnetic force-field imparts substantial momentum to the injected matter.

27. The method of claim 19, wherein the induced electromagnetic force-field is utilized as a force to power the group consisting of at least one of a motor, an engine, a rocket, a turbine, and a direct-drive propulsion.

28. The method of claim 19, further comprising harnessing the energy generated from the nuclear fusion within the vortex to be used as a power source.
